(19) United States
(12) Patent Application Publication
(10) Pub. No.: US 2018/0055016 A1
(43) Pub. Date: Mar. 1, 2018

(54) SYSTEM FOR FACILITATING RECOGNITION OF EMOTIONAL CONDITION AND ABNORMALITY OF AN ANIMAL

(71) Applicant: NUWORLD CORPORATION, Hsinchu City (TW)

(72) Inventors: Jung-Hsi HSIEH, Zhubei City (TW); Jia-Hua HONG, Keelung City (TW); Chun-Hsien LIN, Hsinchu City (TW)

(21) Appl. No.: 15/448,829

(22) Filed: Mar. 3, 2017

(30) Foreign Application Priority Data
Aug. 30, 2016 (TW) 105127797

(51) Int. Cl. A01K 29/00; A01K 27/00; A01K 13/00

(52) U.S. Cl. CPC A01K 29/005; A01K 27/001; A01K 13/006; A01K 27/009; A01K 27/006

(57) ABSTRACT

A system includes a main body worn on an animal, a physiological sensing module generating a physiological signal associated with the animal, a processing module receiving the physiological signal, performing an analytical procedure thereon for obtaining digital data associated with an emotional condition of the animal, and outputting a drive signal, and an indication module receiving the drive signal and outputting an indication message accordingly. A health condition of the animal is recognized by comparing the digital data and predetermined reference data and when the health condition is determined to be abnormal, the indication module is controlled to output a notification message.

### CROSS-REFERENCE TO RELATED APPLICATION

This application claims priority of Taiwanese Invention Patent Application No. 105127797, filed on Aug. 30, 2016.

### FIELD

The disclosure relates to a system for facilitating recognition of emotional condition and abnormality of an animal, and more particularly to a system for facilitating recognition of emotional condition and abnormality of an animal by sensing a physiological condition of the animal.

### BACKGROUND

Lack of an effective and efficient communication method between a pet and an owner thereof hinders the owner from recognizing emotional and health conditions of the pet, so the owner is often unable to perceive occurrences of abnormal conditions in the pet at first. Observing behaviors of the pet on a daily basis or consulting a veterinary professional are few approaches feasible for the owner to recognize emotional and health conditions of the pet. However, these approaches are not effective and efficient ways for promoting interactions between the owner and the pet, and no mechanism is available to prompt the owner to consult the veterinary professional in a timely manner when an abnormal condition occurs in the pet.

### SUMMARY

Therefore, an object of the disclosure is to provide a system for facilitating recognition of emotional condition and abnormality of an animal that can alleviate at least one of the drawbacks of the prior art.

The system includes a main body to be worn on the animal, a physiological sensing module to be disposed on the animal, a processing module disposed on the main body, an indication module disposed on the main body, and a memory module.

The physiological sensing module is configured to generate a physiological signal according to a physiological condition of the animal.

The processing module is electrically connected to the physiological sensing module, and is configured to receive the physiological signal, to perform an analytical procedure on the physiological signal so as to obtain accordingly digital data which represents an emotional condition of the animal, and to output a first drive signal according to the digital data.

The indication module is electrically connected to the processing module, and is configured to receive the first drive signal and to output, according to the first drive signal, an indication message which is associated with the emotional condition of the animal.

The memory module is electrically connected to the processing module, and is configured to store predetermined reference data associated with a normal health condition.

The processing module is further configured to compare the digital data obtained within a preset period with the predetermined reference data so as to determine whether a variation in the emotional condition is normal based on a result of the comparison between the digital data obtained within the preset period and the predetermined reference data. When it is determined that the variation in the emotional condition is abnormal, the processing module outputs a second drive signal. The indication module is further configured to receive the second drive signal and to output, according to the second drive signal, a notification message which notifies that the health condition of the animal is abnormal.

### BRIEF DESCRIPTION OF THE DRAWINGS

Other features and advantages of the disclosure will become apparent in the following detailed description of the embodiments with reference to the accompanying drawings, of which:

FIG. 1 is a schematic diagram illustrating a first embodiment of a system for facilitating recognition of emotional condition and abnormality of an animal according to the disclosure;

FIG. 2 is a block diagram illustrating the first embodiment of the system according to the disclosure;

FIG. 3 is a block diagram illustrating one example of a physiological sensing module of the first embodiment;

FIG. 4 is a flow chart illustrating a method of analyzing the emotional and health conditions of an animal performed by a processing module of the first embodiment;

FIG. 5 is a block diagram illustrating the second embodiment of the system according to the disclosure;

FIG. 6 is a flow chart illustrating an operation flow of the second embodiment;

FIG. 7 is a perspective schematic diagram illustrating one example of a main body of the system according to the disclosure;

FIG. 8 is a fragmentary schematic diagram illustrating an inner side of the main body of said example in a spread state;

FIG. 9 is a fragmentary schematic diagram illustrating an outer side of the main body of said example in the spread state;

FIG. 10 is a schematic diagram illustrating another example of the main body worn on the animal;

FIG. 11 is a schematic diagram illustrating an inner side of the main body of said another example in a spread state; and

FIG. 12 is a schematic diagram illustrating an outer side of the main body of said another example in the spread state.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

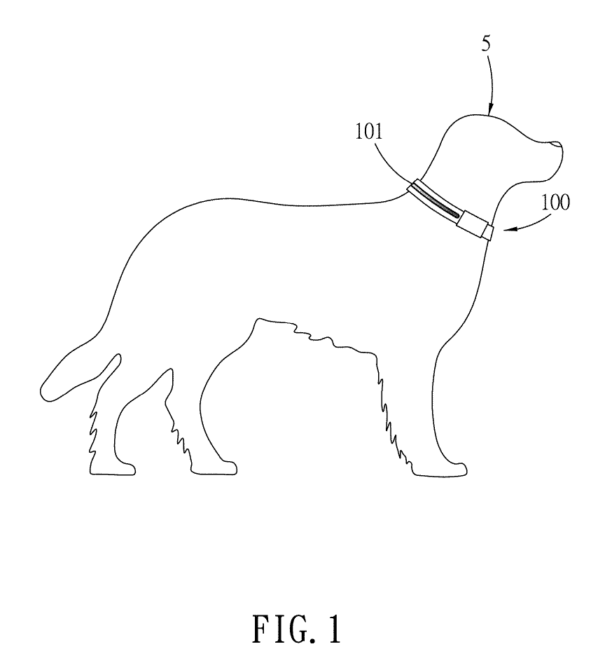

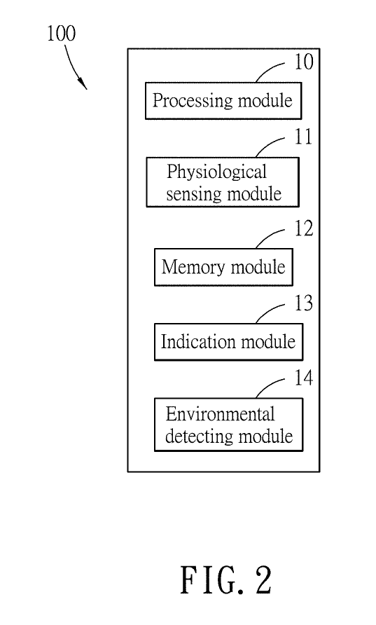

Referring to FIGS. 1 and 2, a first embodiment of a system 100 for facilitating recognition of emotional condition and abnormality of an animal 5 is illustrated. The system 100 includes a main body 101 to be worn on the animal 5, a physiological sensing module 11 to be disposed on the animal 5, a memory module 12, an indication module 13 disposed on the main body 101, an environmental detecting module 14, and a processing module 10 disposed on the main body 101 and electrically connected to the physiological sensing module 11, the memory module 12, the indication module 13, and the environmental detecting module 14.

The physiological sensing module 11 is configured to generate a physiological signal according to a physiological condition of the animal 5 as sensed thereby.

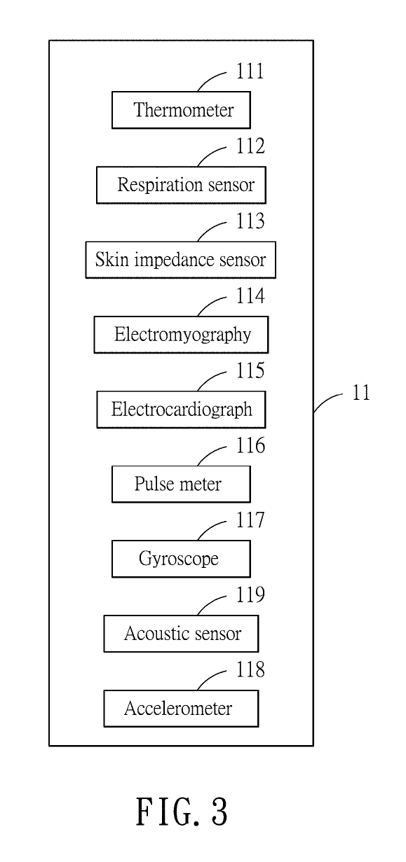

Referring to FIG. 3, the physiological sensing module 11 includes one or more of a thermometer 111, a respiration sensor 112, a skin impedance sensor 113, an electromyography 114, an electrocardiograph 115, a pulse meter 116, a gyroscope 117, an accelerometer 118, and an acoustic sensor 119. In this embodiment, the physiological sensing module 11 includes all of the above-listed components 111-119.

The thermometer 111 generates a thermal signal according to a result of measurement of a body temperature of the animal 5. The respiration sensor 112 generates a respiration signal according to a result of measurement of a respiration rate of the animal 5. The skin impedance sensor 113 generates an impedance value according to a result of measurement of skin impedance of the animal 5. The electromyograph 114 generates an EMG (electromyogram) signal according to a result of measurement of electrical activity produced by skeletal muscles of the animal 5. The electrocardiograph 115 generates an ECG (electrocardiogram) signal according to a result of measurement of electrical activity of a heart of the animal 5. The pulse meter 116 generates a pulse signal according to a pulse of the animal 5. It should be noted that the pulse signal indicates a pulse rate of the animal 5 in this embodiment. However, the pulse signal may, for instance, indicate a pulse amplitude or pulse rate variation of the animal 5 in some embodiments. The gyroscope 117 generates an angular acceleration signal according to a result of measurement of angular acceleration of a corresponding measured part of the animal 5. The accelerometer 118 generates a linear acceleration signal according to a result of measurement of linear acceleration of a corresponding measured part of the animal 5. The acoustic sensor 119 generates an acoustic signal according to a result of measurement of frequency and/or amplitude of sound made by the animal 5, such as respiratory sounds of the animal 5.

At least one of the thermal signal, the respiration signal, the impedance value, the EMG signal, the ECG signal, the pulse signal, the linear acceleration signal, the angular acceleration signal or the acoustic signal serves as the physiological signal mentioned above and is transmitted to the processing module 10. The processing module 10 is configured to receive the physiological signal, to perform a method for analyzing the emotional and health conditions of the animal 5 after receiving the physiological signal. In performing the method, an analytical procedure on the physiological signal is performed by the processing module 10 so as to obtain accordingly digital data which represents an emotional condition of the animal 5. The processing module 10 is further configured to output a first drive signal according to the digital data, and to output a second drive signal when a first predefined condition is satisfied. The drive signals are for driving the indication module 13, details of which will be described later. In this embodiment, the emotional condition may include, but is not limited to, a frustrated state, a normal state, an excited state and an angry state. The processing module 10 is implemented by, but is not limited to, a central processing unit, a microprocessor, an integrated circuit (IC) or a system on a chip (SoC).

The memory module 12 is configured to store predetermined reference data associated with a normal health condition. The predetermined reference data represents a reasonable range of variation in the emotional condition within a preset period. The memory module 12 is implemented by, but is not limited to, a volatile memory, a random access memory (RAM), a non-volatile memory or a flash memory.

Further referring to FIG. 9, in this embodiment, the indication module 13 is a light-emitting module 131, such as an LED module, which is controllable to emit light in different colors and/or at different intensities. It should be noted that implementation of the indication module 13 is not limited to the LED module, and may be a display screen. Moreover, the indication module 13 may be a sound module which is controllable to generate different sounds in other embodiments, and is not limited thereto. The indication module 13 is configured to receive the drive signals from the processing unit 10, and to output, according to the first drive signal, a first indication message which is associated with the emotional condition of the animal 5, and to output in response to receipt of the second drive signal from the processing module 10, a notification message which notifies that the health condition of the animal 5 is abnormal. Different intensities of the first drive signal result in different presentations of the first indication message, and correspond to the different emotional conditions of the animal 5. For example, high to low intensities of the first drive signal correspond respectively to the frustrated state, the normal state, the excited state and the angry state, and different colors and/or different intensities of light emitted by the light-emitting module 131 correspond respectively the different presentations of the first indication message.

To make a relatively faithful indication, the environmental detecting module 14 is included in the system 100 so that environmental influence on the emotional condition of the animal 5 is taken into account. The environmental detecting module 14 is configured to detect an ambient condition surrounding the animal 5 and to output accordingly an environmental signal. In this embodiment, the ambient condition is associated with, but not limited to, temperature, humidity, loudness, luminance, and/or the like. Also, the environmental detecting module 14 may include, but is not limited to, one or more of a thermometer, a hydrometer, a sound level meter and a luminance meter. At the same time, the memory module 12 is further configured to store predetermined environment-related reference data associated with a normal emotional condition of the animal 5 corresponding to at least one specific ambient condition. For example, when the animal 5 is excited merely due to sounds nearby, the emotional condition of the animal 5 should be determined as being the normal emotional condition, rather than being abnormal. In addition, the processing module 10 is further configured to output a third drive signal when a second predefined condition is satisfied in accordance with the digital data and the environmental signal, and the indication module 13 is further configured to generate a second indication message which indicates that the emotional condition of the animal 5 is abnormal in light of the ambient condition upon receipt of the third drive signal from the processing module 10.

In this embodiment, the main body 101 may be made of a flexible material so as to fit animals of different body types when the main body 101 is worn thereon.

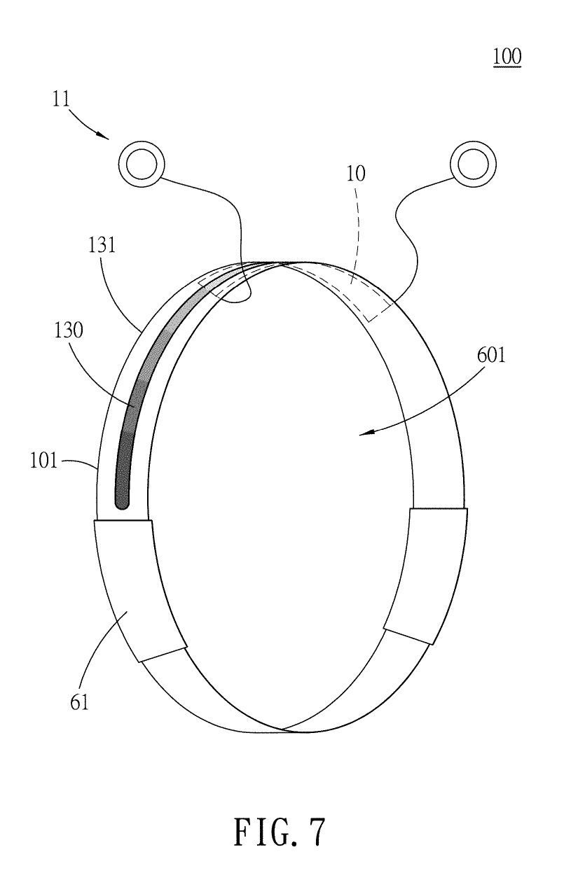

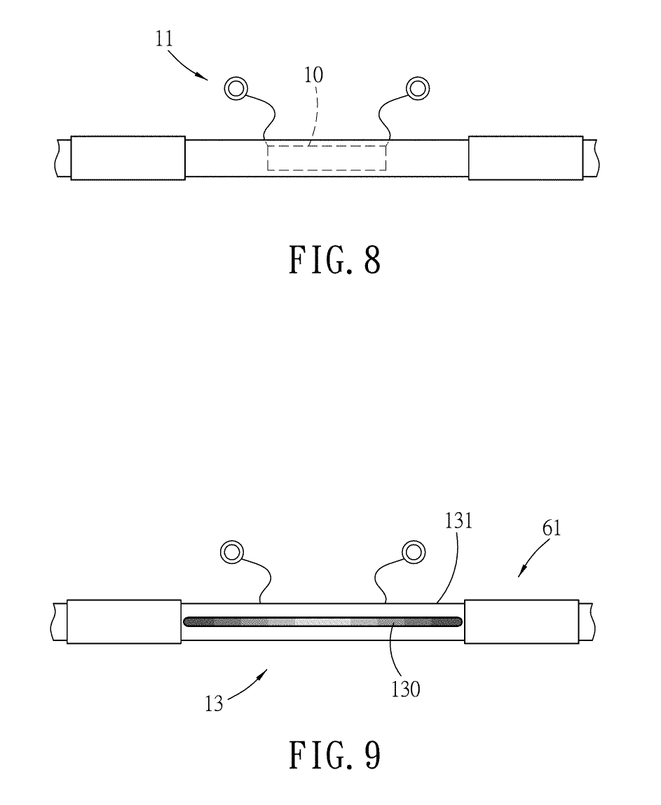

Referring to FIGS. 7 to 9 cooperatively with FIG. 1, one example of the main body 101 of the system 100 worn on the animal 5 is illustrated. In this embodiment, the indication module 13 is the light-emitting module 131 including a strip-shaped light emitting surface 130. The main body 101 is a pet accessory including an encircling portion 61 that serves as a collar and that defines a through hole 601 through which a neck of the animal 5 can pass such that the encircling portion 61 is sleeved on the animal 5. In addition, the strip-shaped light emitting surface 130 is disposed to surround the through hole 601 for emitting light beams outwardly.

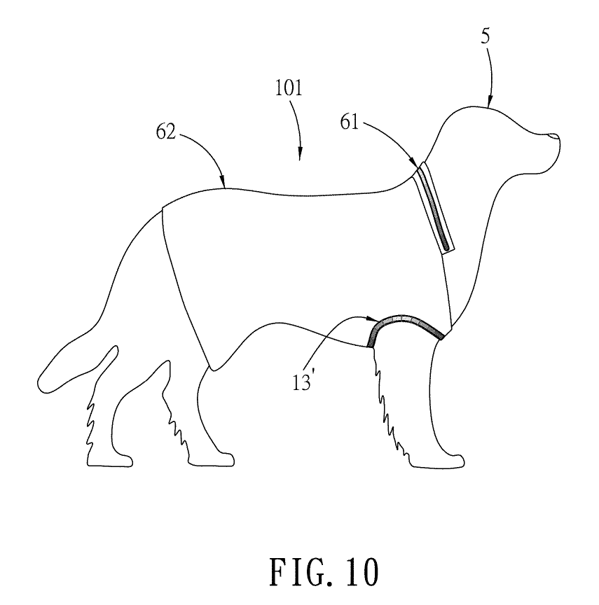

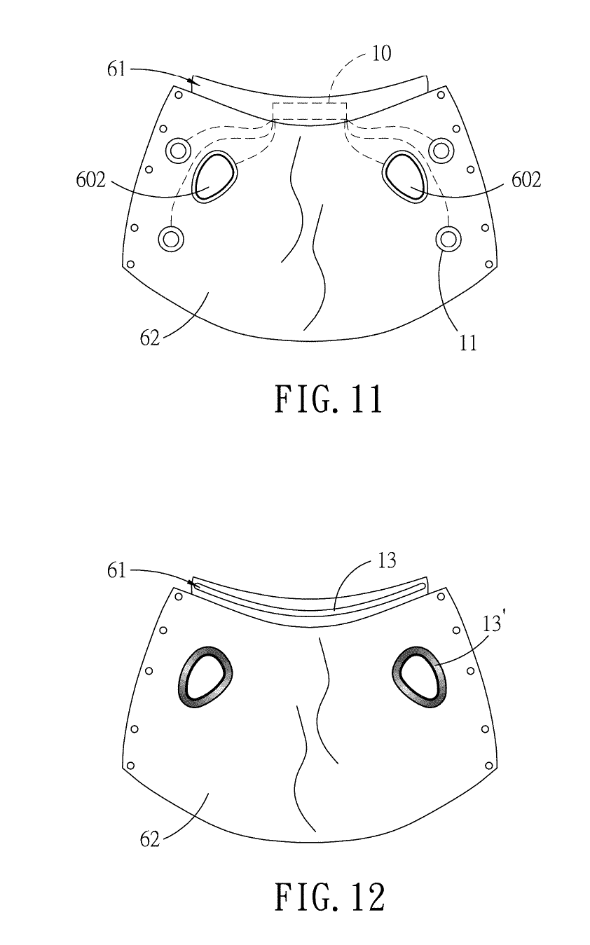

Referring to FIGS. 10 to 12, another example of the main body 101 is illustrated. In this example, similar to the previous one, the pet accessory further includes a vest portion 62 connected to the encircling portion 61. Two through holes 602 serving to allow two limbs of the animal 5 to pass are formed in the vest portion 62. Two additional indication modules 13′ are respectively disposed around the two through holes 602. The indication modules 13, 13′ cooperatively output the first and second indication messages and the notification message, whichever it may be, so as to create a more obvious notification effect. It is worth to note that implementation of the main body 101 may vary in other embodiments. For example, the main body 101 may be formed with a through hole through which a tail of the animal 5 may pass.

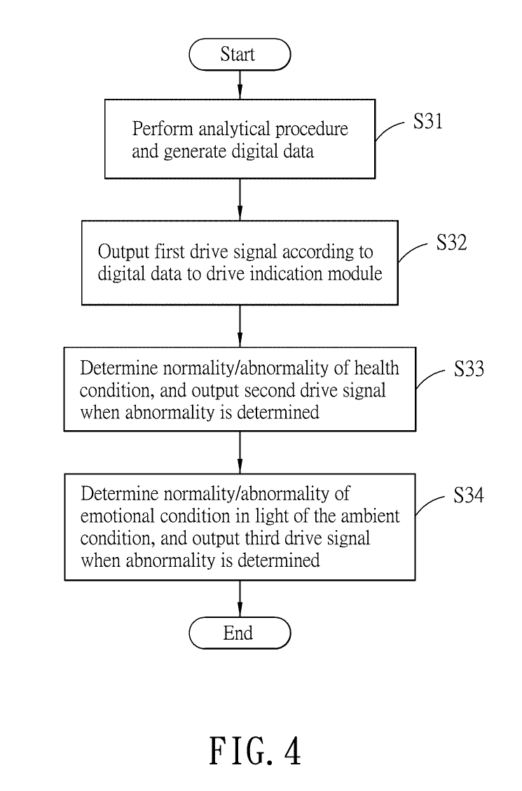

Referring to FIG. 4, the method for analyzing the emotional and health conditions of the animal 5 performed by the processing module 10 after receiving the physiological signal from the physiological sensing module 11 is described below. In one implementation, the method includes steps (S31) to (S34).

In step (S31), the processing module 10 performs the analytical procedure on the physiological signal to obtain the digital data which represents the emotional condition of the animal 5. The analytical procedure includes, but is not limited to, a time-domain analysis step, an averaging step, a frequency-domain analysis step, and an energy calculation step. Performance of the time-domain analysis step results in the digital data of the physiological signal being represented in time domain. Performance of the frequency-domain analysis step results in the digital data of the physiological signal being represented in frequency domain. Performance of the averaging step results in the digital data indicating an average of the physiological signal. Performance of the energy calculation step results in the digital data indicating energy of the physiological signal. Since the emotional state of an animal is generally translated into the physiological state of the animal, the digital data obtained in this step based on the physiological signal is able to represent the emotional condition of the animal 5.

In step (S32), the processing module 10 outputs, to the indication module 13, the first drive signal according to the digital data, so that the indication module 13 is driven to output the first indication message. The presentation of the first indication message differs according to the first drive signal, and facilitates a user (e.g., an owner of the animal 5) to recognize the emotional condition of the animal 5.

In step (S33), the processing module 10 compares the digital data obtained within the preset period with the predetermined reference data so as to determine whether the variation in the emotional condition within the preset period is normal, namely within the reasonable range, (i.e., to determine normality/abnormality of the health condition of the animal 5) based on a result of the comparison between the digital data obtained within the preset period and the predetermined reference data. When it is determined that the variation in the emotional condition is abnormal, i.e., the variation in the emotional condition within the preset period is outside the reasonable range (namely the first predefined condition is satisfied), meaning the health condition of the animal 5 may be abnormal, the processing module 10 outputs the second drive signal to control the indication module 13 to output the notification message which notifies that the health condition of the animal 5 is abnormal.

In step (S34), the processing module 10 determines whether the emotional condition of the animal 5 is considered normal in light of the ambient condition based on a comparison between the digital data in combination with the environmental signal and the predetermined environment-related reference data (the comparison being made to determine whether the second predefined condition is satisfied). When it is determined that the emotional condition of the animal 5 is abnormal in light of the ambient condition (that the second predefined condition is satisfied), the processing module 10 outputs the third drive signal to control the indication module 13 to generate the second indication message which indicates that the emotional condition of the animal 5 is abnormal in light of the ambient condition.

It is worth noting that in this embodiment, the determination of step S34 is made based on the digital data obtained within the preset period. However, in other embodiments, the determination may be made based on the digital data obtained at a single time instant.

Moreover, it should be noted that in this embodiment, the emotional condition, normality/abnormality of the health condition, and normality/abnormality of the emotional condition in light of the ambient condition are determined in sequence as shown in FIG. 4, but may be determined in a different order in other embodiments.

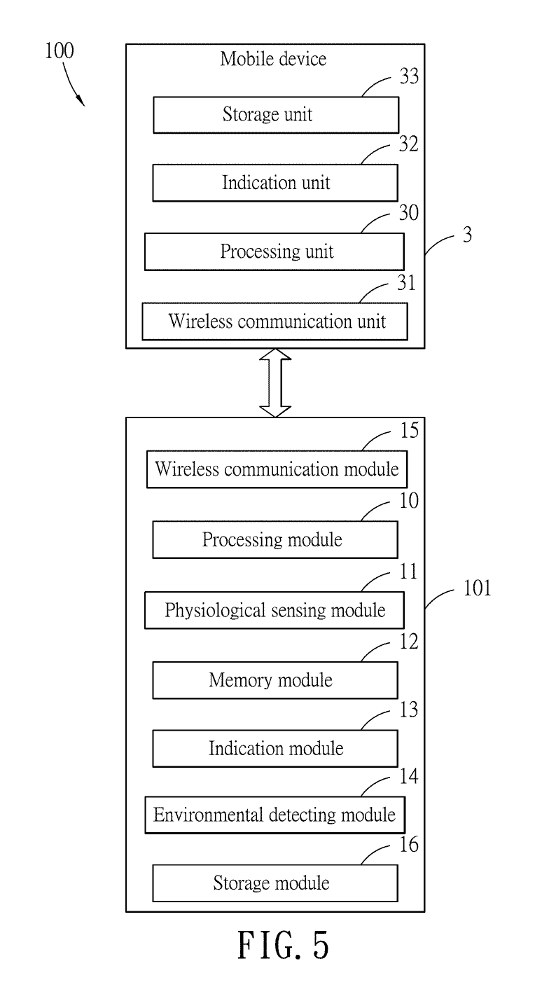

Referring to FIG. 5, a second embodiment of the system 100 for facilitating recognition of the emotional condition and abnormality of an animal 5 (see FIG. 1) is illustrated. The second embodiment of the system 100 is similar to the first embodiment in that the system 100 of the second embodiment includes the main body 101, the processing module 10, the physiological sensing module 11, the memory module 12, the indication module 13 and the environmental detecting module 14, wherein the processing module 10, the physiological sensing module 11, the memory module 12, the indication module 13 and the environmental detecting module 14 are disposed on the main body 101. However, the second embodiment of the system 100 further includes a wireless communication module 15 and a storage module 16 that are disposed on the main body 101 and that are electrically connected to the processing module 10, and a mobile device 3 that is separated from the main body 101 and from the animal 5.

The mobile device 3 includes a processing unit 30, a wireless communication unit 31, an indication unit 32 and a storage unit 33. The mobile device 3 is paired with the wireless communication module 15 on the main body 101 via the wireless communication unit 31.

The processing module 10 is further configured to transmit, via the wireless communication module 15 and the wireless communication unit 31 to the processing unit 30, state data which is associated with the emotional condition, normality/abnormality of the health condition and normality/abnormality of the emotional condition of the animal 5 in light of the ambient condition for allowing the indication unit 32 to output information associated with the state data. As a result, the owner of the animal 5 is able to recognize in real time the emotional condition, normality/abnormality of the health condition and normality/abnormality of the emotional condition of the animal 5 in light of the ambient condition. In this embodiment, the storage unit 33 of the mobile device 3 may be a secure digital (SD) memory card.

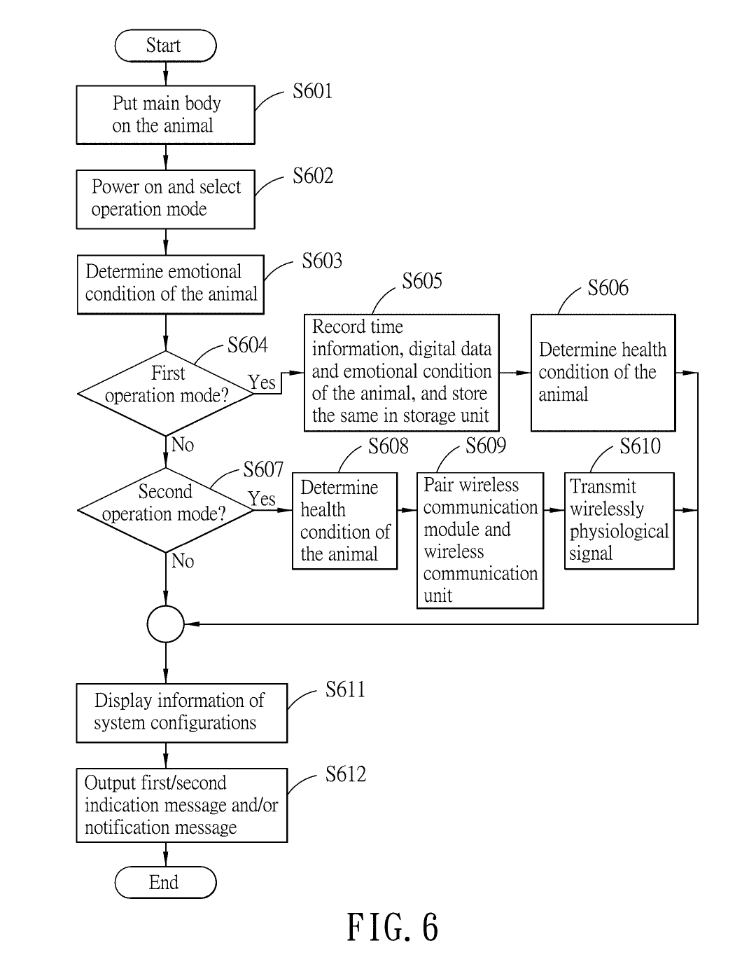

Referring to FIGS. 5 and 6, an operation flow of the system 100 in the second embodiment is described in the following steps (S601-S612).

In step (S601), the main body 101 is put on the animal 5. The main body 101 may be implemented by pet clothing, a collar, or other wearable equipments.

In step (S602), functional circuits (not shown) of the system 100 are powered on and one of multiple operation modes that include a first operation mode (steps (S605, S606)) and a second operation mode (steps (S608-S610)) is selected.

In step (S603), after being powered on, the processing module 10 of the system 100 performs the analytical procedure to obtain the digital data so as to facilitate recognition of the emotional condition of the animal 5 in real time.

In step (S604), the system 100 determines whether to operate in the first operation mode based on the selection made in step (S602) to perform a local health condition analysis for allowing subsequent studying of the digital data and the emotional condition(s) by veterinary professionals

In step (S605), the system 100 records time information with respect to the digital data and to the emotional condition of the animal 5, and stores the time information in combination with the digital data and the emotional condition in the storage unit 33. In consequence, the veterinary professionals can further study the emotional condition (and the health condition) of the animal 5 through the digital data and the emotional condition(s) that is(are) stored thus far.

In step (S606), the system 100 determines normality/abnormality of the health condition of the animal 5 based on the digital data associated with at least one of the body temperature, the respiration rate, the skin impedance, the pulse rate, the electrical activity produced by skeletal muscles, the electrical activity of heart, or the like of the animal 5.

In step (S607), the system 100 determines whether to operate in the second operation mode based on the selection made in step (S602) to perform a remote health condition analysis, such that the physiological signal which is obtained in real time is to be transmitted wirelessly via the mobile device 3 to an external information platform for allowing further study by the veterinary professionals to be conducted.

In step (S608), the system 100 determines normality/abnormality of the health condition of the animal 5 based on the digital data associated with at least one of the body temperature, the respiration rate, the skin impedance, the pulse rate, the electrical activity produced by skeletal muscles, the electrical activity of heart, or the like of the animal 5.

In step (S609), the wireless communication module 15 on the main body 101 and the wireless communication unit 31 of the mobile device 3 are paired and/or connected by technologies such as Bluetooth and Wi-Fi, but implementations of the pairing and connection are not limited thereto.

In step (S610), the system 100 transmits wirelessly the physiological signal obtained in real time via the paired wireless communication module 15 and the mobile device 3 to the external information platform, such that the veterinary professionals can further study remotely the health condition of the animal 5 based on the physiological signal.

In step (S611), the system 100 displays information of configurations of the system 100, such as activation/deactivation of functionality of facilitating recognition of the emotional condition of the animal 5, activation/deactivation of functionality of determining normality/abnormality of the health condition of the animal 5, activation/deactivation of functionality of wireless transmission, activation/deactivation of functionality of storage of the digital data, remaining battery capacity of the system 100, and so on. Display of the aforesaid information may be implemented by, but not limited to, light-emitting diodes (LEDs) or a display screen.

In step (S612), the system 100 outputs by the indication module 13 the first indication message and/or the second indication message which are associated with the emotional condition and/or the notification message which is associated with the health condition of the animal. Through observing the first and second indication messages and/or the notification message, which may be light emitted by the LEDs in different colors or light variations, the owner of the animal 5 can recognize the emotional condition and/or the health condition of the animal 5.

In summary, the system 100 of this disclosure determines whether at least one of the emotional condition or the health condition of the animal 5 is abnormal by cooperation between the processing module 10 and the physiological sensing module 11. When either the emotional or health condition is determined as abnormal, the processing module 10 controls the indication module 13 to generate a corresponding message (either the notification message or the second indication message, depending on the determination, to notify anyone who is near the animal 5, so that he/she can take an appropriate action in view of the condition the animal 5 is in. Furthermore, taking account of the ambient condition to which the animal 5 is subjected, the system 100 is capable of determining objectively the normality/abnormality of at least one of the emotional condition or the health condition of the animal 5 based on the physiological signal obtained.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A system for facilitating recognition of emotional condition and abnormality of an animal, said system comprising:
a main body to be worn on the animal;
a physiological sensing module to be disposed on the animal and configured to generate a physiological signal according to a physiological condition of the animal;
a processing module disposed on said main body, electrically connected to said physiological sensing module, and configured to receive the physiological signal, to perform an analytical procedure on the physiological signal so as to obtain accordingly digital data which represents an emotional condition of the animal, and to output a first drive signal according to the digital data;
an indication module disposed on said main body, electrically connected to said processing module, and configured to receive the first drive signal and to output, according to the first drive signal, a first indication message which is associated with the emotional condition of the animal;
a memory module electrically connected to said processing module, and configured to store predetermined reference data associated with a normal health condition; and
wherein said processing module is further configured to compare the digital data obtained within a preset period with the predetermined reference data so as to determine whether a variation in the emotional condition is normal based on a result of the comparison between the digital data obtained within the preset period and the predetermined reference data, and when it is determined that the variation in the emotional condition is abnormal, said processing module outputs a second drive signal, said indication module being further configured to receive the second drive signal and to output, according to the second drive signal, a notification message which notifies that the health condition of the animal is abnormal.

2. The system as claimed in claim 1, further comprising:
an environmental detecting module electrically connected to said processing module and configured to detect an ambient condition surrounding the animal and to output accordingly an environmental signal;
wherein said memory module is further configured to store predetermined environment-related reference data associated with a normal emotional condition of the animal corresponding to a specific ambient condition;
wherein said processing module is configured to determine whether the emotional condition of the animal is normal in light of the ambient condition based on a comparison between the digital data in combination with the environmental signal and the predetermined environment-related reference data, and when it is determined that the emotional condition of the animal is abnormal in light of the ambient condition, said processing module outputs accordingly a third drive signal, said indication module being further configured to receive the third drive signal and to output, according to the third drive signal, a second indication message which indicates that the emotional condition of the animal is abnormal in light of the ambient condition.

3. The system as claimed in claim 2, further comprising:
a wireless communication module electrically connected to said processing module; and
a mobile device separated from said main body and paired with said wireless communication module;
wherein said processing module is further configured to transmit, via said wireless communication module to said mobile device, state data which is associated with the emotional condition, normality/abnormality of the health condition and normality/abnormality of the emotional condition of the animal in light of the ambient condition for allowing said mobile device to output information associated with the state data

4. The system as claimed in claim 2, wherein said environmental detecting module includes one or more of a thermometer, a hydrometer, a sound level meter and a luminance meter.

5. The system as claimed in claim 1, wherein said indication module includes at least one of a light-emitting module which is controllable to emit light in different colors, or a sound module which is controllable to generate different sounds.

6. The system as claimed in claim 1, wherein said physiological sensing module includes one or more of a thermometer, a respiration sensor, a skin impedance sensor, an electromyograph, an electrocardiograph, a pulse meter, a gyroscope, an accelerometer, and an acoustic sensor.

7. The system as claimed in claim 1, wherein the analytical procedure includes at least one of a time-domain analysis step, an averaging step, a frequency-domain analysis step, or an energy calculation step.

8. The system as claimed in claim 1, wherein:
said main body is a pet accessory including an encircling portion defining at least one through hole through which at least one of a neck, a limb or a tail of the animal passes such that said encircling portion is to be sleeved on the animal; and
said indication module is a light-emitting module including a strip-shaped light emitting surface which is disposed around said through hole for emitting light beams outwardly.
